(19) United States
(12) Patent Application Publication
(10) Pub. No.: US 2005/0014429 A1
(43) Pub. Date: Jan. 20, 2005

(54) Wire mesh panel and method

(76) Inventors: Ruediger Tueshaus, Dorsten (DE); Patrick McGrenera, The Woodlands, TX (US)

Correspondence Address: KENNETH L. NASH, P.O. BOX 680106, HOUSTON, TX, 77268-0106, US

(21) Appl. No.: 10/620,544

(22) Filed: Jul. 16, 2003

(51) Int. Cl. D04B 1/00; B32B 17/02

(52) U.S. Cl. 442/6; 442/27; 428/131; 428/304.4; 428/432

(57) ABSTRACT

An assembly and method is provided for a decorative screen, wall, or other surface to provide a desired amount of light passing through, reflected by, and/or diffused by the decorative screen. In one preferred embodiment, at least one screen is formed of a plurality of wires that are woven together. The screen is preferably affixed within one or more transparent panels. In one embodiment, the screen may preferably have an arrangement with a number of wires having wire diameters in a selected weave or knitted pattern such that only between zero and eighty-five percent of the surface area of the screen is open area. The wire is preferably treated such that a desired level or amount metal luster is provided to control reflection/absorbtion properties of the screen. The screen may be utilized as building material such as walls, counters, shower enclosures, or to make other articles such as furniture.

### TECHNICAL FIELD

The present invention relates generally to glass and, more specifically, to laminated glass or glass-like material embedded with a metallic mesh.

### BACKGROUND

Safety glass, also known as wired glass, is well known in the prior art. Safety glass may utilize a wire mesh support as discussed in more detail in the cited patents listed hereinafter. Safety glass is utilized to provide protective windows that permit visual perception therethrough. Accordingly, the wire mesh utilized in prior art safety glass is typically of very small diameter wire with wide openings in the mesh so as to avoid obstructing vision through the glass. Due to the small diameter wire mesh with large openings therein that permit maximum vision therethrough, there is effectively very little inherent strength in this wire mesh. To increase the strength of the wire mesh utilized in safety glass, the wire mesh is formed by twisting the wires together at each connection and/or welding the mesh.

The prior art safety glass focuses on minimizing the appearance of the wire inside the glass. The result of using relatively few strands of minimized diameter wire in the support mesh significantly improves the ability to look through the glass by blocking only a very small percent or a fraction of a percent of the light through the safety glass, but also provides a relatively low strength glass support structure as compared to many other reinforcing materials.

The following patents show prior art related to the above:

U.S. Pat. No. 2,511,168, issued Jun. 13, 1950, to J. S. Martin et al., discloses the construction and mounting of units of transparent synthetic resins, such as sheets, panels and structural components, and proposes a mounting extension or member secured to and projecting from the unit in such a manner that for all practical purposes it becomes an integral part thereof and embodies all the favorable characteristics of the unit, at the same time avoiding and eliminating the disadvantages which have heretofore characterized the mounting of elements or units.

U.S. Pat. No. 3,953,630, issued Apr. 27, 1976, to Roberts et al., discloses a laminated transparent assembly suitable for use as a windscreen for a high speed vehicle, e.g., an aircraft or railway locomotive, which comprises a load-bearing sheet of toughened glass having a second sheet of glass laminated thereto by means of an impact resistant interlayer of plastics material, e.g., polyvinylbutyral, and an insert of high tensile strength flexible material which extends around the periphery of the interlayer and which has an inner part embedded in the outer marginal portion of the interlayer in a plane parallel to the surfaces of the interlayer, and an outer part extending outwardly beyond the edges of the interlayer to provide for attachment of the assembly to the structure of the vehicle. The insert is preferably a sheet of fabric material, e.g., a fabric woven from rubber-impregnated glass fiber cords and nylon, with the glass fiber cords substantially perpendicular to the adjacent edges of the assembly, embedded between layers of soft polyvinylbutyral. The outer part of the insert may have a flexible portion adjacent to the edges of the interlayer and an outer marginal portion which is reinforced, e.g., with metal, to render it rigid to provide means for attachment of the assembly to the vehicle structure.

U.S. Pat. No. 3,954,547, issued May 4, 1976, to Werner Genthner, discloses the production of safety glass with a plastic sheet as an intermediate layer, using wires such as electrical heating wires, which are fixed on the plastic sheet in their final (for instance, undulating) shape in a stress free condition.

U.S. Pat. No. 4,020,217, issued Apr. 26, 1977, to Karasudani et al., discloses a laminated safety glass structure which comprises at least two glass sheets bonded to each other through an interlayer of a plasticized polyvinyl acetyl resin treated with a specific modified siloxane alone or together with a specific alkali metal or alkaline earth metal salt of an organic mono- or di-carboxylic acid. This structure has a highly improved penetration resistance along with superior transparency, aging resistance and weatherability, and is suitable for use as windowpanes in transportation facilities and buildings.

U.S. Pat. No. 4,173,668, issued Nov. 6, 1979, to Hentzelt et al., discloses a fire-screening panel that maintains its effectiveness in preventing fire propagation even after aging of the panel. The panel comprises a first structural ply formed from a vitreous sheet, and a second structural ply, with a layer of intumescent material disposed therebetween. Other plies may also be provided, and the plies are clamped together in face-to-face relationship, and/or bonded together. At least one ply of the panel has an infra-red reflecting coating disposed thereon, remote from the intumescent material, which coating provides for the retained effectiveness of the fire-propagating properties of the panel despite aging thereof.

U.S. Pat. No. 4,173,672, issued Nov. 6, 1979, to Jose R. Mannheim, discloses a method to decorated laminate glass comprised of two glass sheets joined by a decorated film of a thermoplastic polymer. A sheet of glass, the film and a lamina of cellulosic material, decorated on the surface that contacts the film, are subjected to pressure and heat so as to transfer, by sublimation, the decoration to the film at the moment that it adheres itself to the surface of the glass. A second sheet of glass is over-placed on the decorated film and pressed to it, with heat, so as to form a safety glass decorated and/or colored in the interior.

U.S. Pat. No. 4,642,255, issued Feb. 10, 1987, to Frank C. Dlubak, discloses a laminated article comprising two outer glass layers, a polyvinyl acetyl layer disposed therebetween and a fibrous layer encapsulated in the polyvinyl acetyl layer; and a process for producing the laminated article comprising (1) maintaining a substantially constant vacuum in a flexible container containing an assembly comprising (a) a first glass layer, (b) a first polyvinyl acetyl layer in contact with the first glass layer, (c) a fibrous layer in contact with the first polyvinyl acetyl layer, (d) a second polyvinyl acetyl layer in contact with the fibrous layer and (e) a second glass layer in contact with the second polyvinyl acetyl layer; (2) applying pressure on the container while increasing the same from about ambient pressure to an elevated pressure level and simultaneously increasing the temperature on the contents of the container from about ambient temperature to an elevated temperature level; (3) reducing the temperature on the contents of the container from the elevated temperature level to about ambient temperature; and then (4) reducing the pressure on the container from the elevated pressure level to about ambient pressure.

U.S. Pat. No. 4,824,722, issued Apr. 25, 1989, to Kenneth B. Jarrett, discloses a safety glass laminate comprising a first sheet of organic or inorganic glass and a second rigid sheet, which may also be of organic or inorganic glass, with a flexible plastics interlayer therebetween bonded to each of the sheets by adhesive which has been cured by irradiation, the interlayer comprising two outer layers of plastics film and an inner layer of fabric, preferably woven polyester, interposed therebetween. The laminate may, for example, be employed as decorative cladding or as a panel for a glass door. A security window may be provided in the laminate.

U.S. Pat. No. 5,219,630, issued Jun. 15, 1993, to James A. Hickman, discloses a fire-resistant safety glazing product which comprises at least two sheets of glazing material, e.g. glass, bonded together with an interlayer of adhesive binder material and metallic wire mesh of the type used in “wired glass” embedded in the interlayer. Methods of manufacturing fire-resistant safety glazing products are disclosed.

U.S. Pat. No. 5,230,954, issued Jul. 27, 1993, to Sakamoto et al., discloses a fire protective glass panel for use in a fire protective window, door, and partition wall, which comprises at least one sheet of fireproof glass plate and a fluorocarbon resin film of a chain molecular structure type bonded to a side surface of the glass plate and which has non-shattering property as well as fire protection property wherein the fireproof glass plate is a heat-resistant and light transparent crystallized glass plate or, alternatively, the fireproof glass plate is a wire glass plate and the fluorocarbon resin film has a thickness of 0.02-1 mm and is made of one of FEP, PFA, PCTFE, ETFE, and PVDF.

U.S. Pat. No. 5,462,805, issued Oct. 31, 1995, to Sakamoto et al., discloses a fire-protection and safety glass panel having a transparent appearance and dual functions as a fire protection glass for shutting out flame and smoke for a long period of time upon occurrence of fire and as a safety glass which is neither shattered into pieces nor forms any through hole if it is broken in an ordinary life. A PET (polyethylene terephthalate) film is arranged between a first glass plate and a second glass plate. The first and the second glass plates and the PET film are adhered through transparent acrylic adhesive agent layers, respectively. An intermediate resin layer comprises the PET film and the adhesive agent layers and has a thickness between 75 and 200 micrometers.

U.S. Pat. No. 5,506,051, issued Apr. 9, 1996, to Levy-Borochov et al., discloses an improved transparent bullet-proof laminate which is formed with an energy absorbing transition layer located between preformed laminae of glass and/or plastic, such as polycarbonate, the transition layer constituting a cured aliphatic urethane acrylate with optionally up to 70% of a monofunctional monomeric acrylate, the transition layer in liquid form having a viscosity preferably no greater than 1000 cps and in cured state having a toughness of at least 0.1 MPa, and elastic modulus no greater than 25 MPa and an elongation of at least 20%.

U.S. Pat. No. 5,908,704, issued Jun. 1, 1999, to Friedman et al., discloses optical and fire screening protective glazing laminates comprising fluoropolymer interlayer films. The films and their laminates comprise THV and blends of THV with FEP, ECTFE or ECCTFE, and modified with additives, such as coupling agents, pigment or color concentrates, and IR- or UV- light blockers, and may be subjected to a surface corona treatment. The films also may incorporate a fiber mesh for additional reinforcement.

U.S. Pat. No. 5,944,862, issued Aug. 31, 1999, to Stephen Edwin Howes, discloses a decorative window which consists of thick transparent plastic resin layer laminated to a sheet of glass. The outer surface of resin layer includes decorative features, such as deeply contoured pictographic images and finely detailed textured surfaces. The decorative window is produced as replica of a glass master originally made using conventional grinding and surfaces finishing techniques. The master is then covered with a mixture of silicone, catalysts for curing the silicone, and a light oil to form a mold. After curing, the mold is removed from the glass master, inverted and a glass sheet, which has been prepared for the process by being coated with organosilane ester, is clamped thereto. The mold cavity is then filled with a mixture of a clear plastic resin, catalysts for curing the resin, and organosilane ester. After curing, the replicated decorative window is removed from the mold.

U.K. Patent Application GB 2,078,166A, published Jan. 6, 1982, to Ugo Pacella, discloses composite sheet material that is built-up of a plurality of single plates joined together by means of one or more interposed biadhesive tapes. The composite sheet may be provided with a colored or reflecting film and may comprise in addition inserts formed of films or wires provided for increasing the strength of the sheet or for serving as parts of electric heating or alarm circuits. The process for making the sheets provides for the application of the biadhesive tapes without the forming of air pockets and for a compression effect acting over the whole surface of the composite sheet within an autoclave. The single plates forming the sheet may be of glass, polycarbonate, or other synthetic material. The biadhesive tape is preferably provided on both sides with a protective film, to be removed before the application of the tape and the adhesive securement together of the single plates.

U.K. Patent Application GB 2,125,732A, published Mar. 14, 1984, to Carl-Zeiss-Stiftung, discloses a composite glass and/or vitreous ceramic-bonded system for application as shielding against microwave radiation which comprises between at least one supporting plate and at least one cover plate made of glass and/or vitreous ceramic material, a metallic microwave-impermeable shield which is non-detachably adhesively bonded to the plates by means of a viscously elastic and/or permanently elastic cement, the metallic shield being conducted in out of the bonded unit in such a manner as to enable it being connected in microwave sealed fashion to an adjoining frame and/or to mounting means. The composite system may be used, for example, as a viewing or observation panel for microwave-charged chambers.

U.K. Patent Application GB 2,155,856A, published Oct. 2, 1985, to James Arthur et al., discloses a method of producing a laminate which comprises arranging a pair of sheets, e.g. of glass, face-to-face and at an incline to the horizontal with a lower portion of the periphery of the sheets sealed in a substantially liquid tight manner by non-porous adhesive strip material sandwiched between the sheets. Settable liquid resin material is poured between the sheets through at least one filling opening along an upper portion of the periphery of the sheets. When all the resin material has been introduced, the upper portion of the sheet periphery is sealed with the exception of air gaps, the sheets are lowered to a horizontal position to enable air to be expelled through the air gaps, and the liquid resin material is allowed to set.

The above patents do not disclose solutions to the problems discussed above. Consequently, there remains a need to provide an improved glass or glass-like translucent or transparent material with embedded decorative metal. Those of skill in the art will appreciate the present invention which addresses the above and other problems.

### SUMMARY OF THE INVENTION

An objective of the present invention is to provide an improved panel with a decorative metallic reinforcement.

Another objective the present invention is provide a means for selectively controlling light reflected by, passing through, or diffused by a decorative wire mesh panel embedded in translucent or transparent material.

These and other objectives, features, and advantages of the present invention will become apparent from the drawings, the descriptions given herein, and the appended claims. However, it will be understood that above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

Accordingly, the present invention provides a method for making construction material comprising a decorative panel comprising one or more steps such as, for instance, determining a desired amount of light to be passed by the flat panel ranging from zero percent to eighty-five percent, and/or controlling construction of a wire mesh comprising a first plurality of wires and a second plurality of wires to provide the desired amount of light to be passed by the flat panel, and/or mounting the wire mesh to the one or more plates of substantially transparent material.

The step of controlling may comprise controlling at least two of a group consisting of selecting a wire mesh weave, selecting twists in wires, selecting a percentage of open regions of the wire mesh, selecting one or more cross-sectional shapes for the first plurality of wires and the second plurality of wires, selecting a diameter of the first plurality of wires and the second plurality of wires.

In another embodiment, a method comprises one or more steps such as determining a desired amount of light to be reflected by the flat panel ranging from fifteen percent to one hundred percent, and/or controlling construction of a wire mesh comprising a first plurality of wires and a second plurality of wires to provide the desired amount of light to be reflected by the flat panel, and/or mounting the wire mesh to the one or more plates of substantially transparent material.

The step of controlling may comprise controlling at least two of a group consisting of selecting a wire mesh weave, selecting twists in wires, selecting a percentage of open regions of the wire mesh, selecting one or more cross-sectional shapes for the first plurality of wires and the second plurality of wires, selecting a diameter of the first plurality of wires and the second plurality of wires, selecting a texture of the first plurality of wires, selecting a type of metal or alloy, and the second plurality of wires and selecting a reflectance of the first plurality of wires and the second plurality of wires.

In another embodiment the invention comprises producing a substantially flat and easily cleaneable smooth surface with an internal decorative and textured wire screen.

The present invention comprises, in another embodiment thereof, a decorative construction assembly. The invention may comprise one or more elements such as, for instance, one or more substantially transparent panels and/or a wire mesh mounted within therein. The substantially flat panel may be rigid but could also be substantially bendable. The wire mesh may comprise a first plurality of wires and a second plurality of wires in at least one weave pattern or knitted pattern. In one embodiment, the wire mesh may act as a curtain in the glass whereby light passes but it is difficult to see what is behind the panel, especially from a distance. This embodiment may be of use for a dressing curtain or shower enclosure. The first plurality of wires may be interwoven with a second plurality of wires. The wire mesh may be woven with a twilled weave or variation thereof and/or the wire mesh may be woven in a Dutch weave or variation thereof and/or the wire mesh may be woven in a heddle weave or variation thereof. A few examples of other weaves include plain weave, twill weave, 5-heddle weave and/or other woven variations. The first plurality of wires may interconnect with the second plurality of wires at a plurality of intersections. Each of the plurality of intersections may comprise individual wires extending therefrom, whereby the individual wires engage each other but are preferably not twisted around each other so as to loop around each other. The second plurality of wires may have a cross-section with at least one planar side. Either the first plurality of wires or the second plurality of wires may have a non-round cross-section.

The decorative construction assembly may further comprise a transparent adhesive for securing the wire mesh within at least one first layer of substantially transparent material and at least one second layer of substantially transparent material. The wire mesh may have a surface area and may define openings therein that permit light through the wire mesh, whereby a percentage of the openings with respect to a total surface area of the wire mesh is in a range from zero to eighty-five percent. Alternative the range of open area may be smaller such as between zero and twenty percent or forty percent. The wire mesh may have a lustrous surface.

In another embodiment, the decorative construction material may comprise one or more elements, such as, for instance, weaving or knitting a first plurality of wires with a second plurality of wires to form a wire mesh. Depending on the embodiment, the wires may or may not be welded. In another embodiment, a metallic plate or sheet may also be stamped and/or stamped to produce an opening and which is then widened. The individual wires in the wire mesh preferably intersect without looping completely around each other. However, the mesh could be knitted by utilizing a plurality of knitting needles. The wire mesh preferably has between zero and eighty five percent open areas through the mesh. However, the wire mesh openings could also be between zero and fifty, forty, thirty, or twenty percent, depending on the decorative design. In one embodiment, the wire mesh may be mounted between a plurality of substantially transparent panels in laminar construction and may preferably be affixed to the plurality of substantially transparent panels. In another embodiment, the wire mesh may be integral or melted into the transparent panels. The wire mesh may be affixed by adhering the wire mesh to the plurality of substantially transparent panels and/or by fastening the wire mesh to the plurality of substantially transparent panels with a fastener.

The decorative construction material may be constructed into an assembly that may be used to form a portion of a building wall, and/or the decorative construction material may be constructed into an assembly that may be used to form a portion of an article of furniture. Many other construction uses are also possible, e.g., counter tops, glass curtains, shower enclosures, cubical walls, and the like.

A wall portion may comprise a wire mesh embedded within a plurality of translucent panels. The wire mesh may comprise woven filaments in a selected weave pattern such that open area through the wire mesh comprises less than eighty-five percent of an overall area of the wire mesh. The wall portion is preferably mounted. In one embodiment, the wall portion may be mounted in furniture. In another embodiment, the wall portion may be mounted as a wall for a building.

In one embodiment, the wire mesh may possibly be cut into a desired pattern, such as, for example only, geometric patterns, animal patterns, circles, automobiles, or any other types of patterns. The wire mesh preferably contains a lustrous surface.

This summary is not intended to be a limitation with respect to the features of the invention as claimed, and this and other objects can be more readily observed and understood in the detailed description of the preferred embodiment and in the claims.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a perspective view showing one embodiment of a decorative wire mesh embedded in glass, plastic, or other preferably relatively clear materials, in accord with the present invention;

FIG. 2 is a perspective view showing another embodiment of a decorative wire mesh embedded in glass, plastic, or other preferably relatively clear materials, in accord with the present invention;

FIG. 3 is an elevational view, in cross-section, of yet another embodiment of a decorative wire mesh in glass, plastic, or other preferably relatively clear materials, in accord with the present invention;

FIG. 4 is a perspective view showing yet another embodiment of a decorative wire mesh embedded in glass, plastic, or other preferably relatively clear materials, in accord with the present invention;

FIG. 5 is a perspective view showing another embodiment of a decorative wire mesh embedded in glass, plastic, or other preferably relatively clear materials, in accord with the present invention;

FIG. 6 is a perspective view showing use of a first cross-sectional shaped filament, in this case a twisted planar surfaced filament, with a second different cross-sectional shaped filament, in this case a round filament, which may be used in the decorative wire mesh, in accord with the present invention;

FIG. 7 is an elevational view, in cross-section, showing a plurality of cross-sections of some different types of wire filaments for use in the decorative wire mesh, in accord with the present invention;

FIG. 8 is an elevational view, in cross-section, showing another embodiment of a decorative wire mesh embedded in glass, plastic, or other preferably relatively clear materials, in accord with the present invention;

FIG. 9 is an elevational view, partially in cross-section, showing a welded mesh structure embedded in glass, plastic, or other preferably relatively clear materials, in accord with the present invention;

FIG. 10 is an elevational view showing a shaped decorative wire mesh, in this case a circle, embedded in glass, plastic, or other preferably relatively clear materials, in accord with the present invention;

FIG. 11 is an elevational view showing a decorative wire mesh embedded in clear glass or plastic with a cut out shape, in this case a circle, in accord with the present invention;

FIG. 12 is an elevational view showing a decorative wire mesh figurine, in this case a frog, embedded in glass or plastic, in accord with the present invention;

FIG. 13 is a perspective view of a glass-top table using decorative wire mesh embedded in the clear glass or plastic top, in accord with the present invention; and

FIG. 14 is an elevational view showing another embodiment of a decorative wire mesh embedded in clear glass or plastic used as a wall or divider, in accord with the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

### GENERAL DESCRIPTION OF PREFERRED EMBODIMENTS FOR CARRYING OUT THE INVENTION

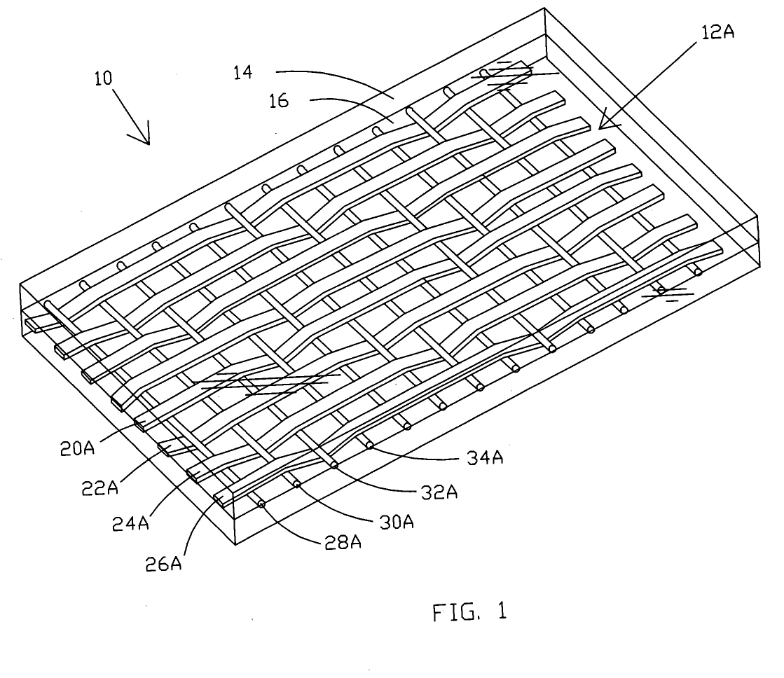

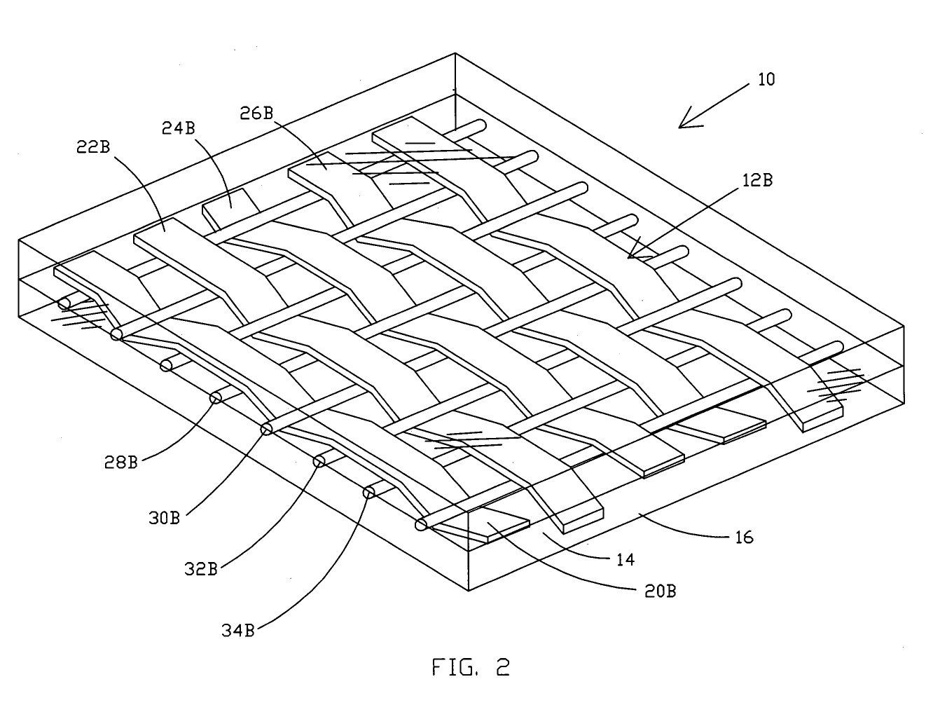

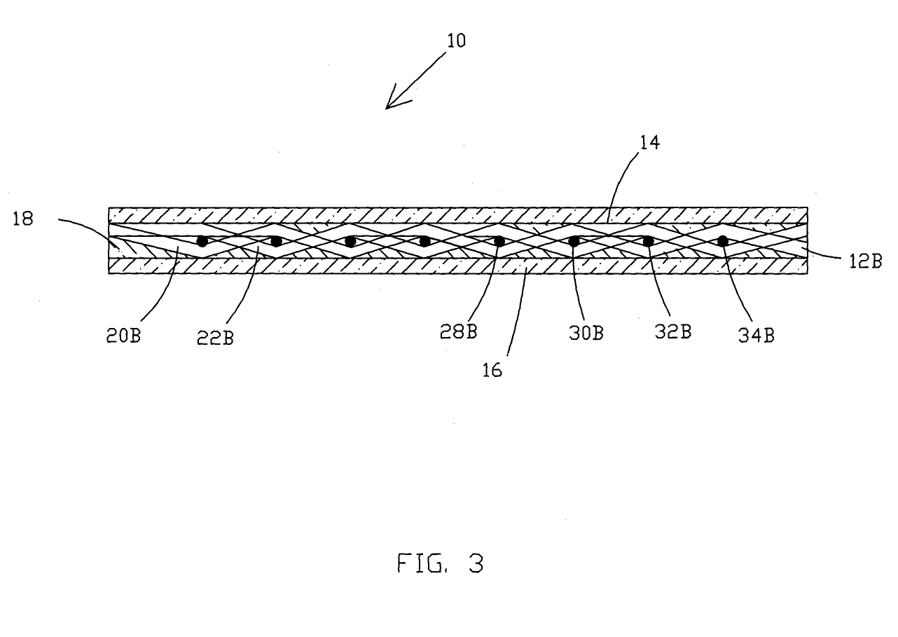

Referring now to the drawings and, more particularly to FIG. 1, FIG. 2, and FIG. 3, there is shown wire mesh panel 10 which comprises wire meshes 12A and 12B which are mounted within upper transparent panel 14 and lower transparent panel 16. The wire mesh utilized in wire mesh panel 10 may comprise many different types, including many different weaves, knits, and constructions. Wire mesh panel 10 is generally designed to have much less open area than prior art safety glass and may typically have open area in the range from zero to eighty-five percent as compared to the total area of the wire mesh but could comprise other ranges e.g., less than forty percent. In fact, in some cases it may be desirable to provide wire mesh with very small open areas or to completely close off the open areas thereby blocking vision therethrough such as for a show enclosure or dressing room curtain. Archeitects may be able to select a panel based on light passing through, light reflected, light absorbed, light scattered back or diffused when passing through panel 10. Thus, an archeitect may initially select such factors in order to choose a desired panel.

Typically, the open area will be less than about fifty percent of the total area of the wire mesh but could be a smaller or larger percentage. The reflectance of the wire mesh is also controlled. Different sides of the wire mesh panel may have different amounts of reflectivity. A preferred range of reflectance ranges from total reflectance of the light, up to one hundred percent to a smaller amount of reflectance such as about fifteen percent.

The wire mesh is preferably selected not only for strength but also for aesthetic purposes. Accordingly, one possible object of the invention is not necessarily to enhance vision through wire mesh panel 10 but instead to provide a generally very strong and aesthetically pleasing construction panel that may be utilized for a wide variety of construction purposes such as in furniture, building walls, and the like. The wire diameters may have a fairly wide range of diameters such as between 0.02 mm to 2 mm or larger. As the diameter decreases, additional wire strands are utilized to keep the open areas smaller. The wires may be of any type such as copper or stainless alloys or any suitable wire with any type of finish. In one embodiment, due to the limited open areas, most of the light striking panel, will be reflected and/or absorbed.

In another embodiment, the wire mesh panel is suitable for use in hygenic environments. For instance, screens may presently be provided in hygenic environments such as restaurants, hospitals, and the like which are difficult to clean. The present invention provides an easily cleanable panel with the aesthetic appeal providing by a screen.

In FIG. 1-FIG. 3, wire mesh 12A is woven with planar surfaced members such as filaments, wires or the like. However, other types of wires or combinations of different types of wires could also be utilized. The wires may or may not comprise insulated wires, which could be colored, although in a preferred embodiment, non-insulated wires are utilized. The wire mesh may also employ numerous different weaves, openings, and constructions only a few of which are shown herein. As used herein, terms such as filaments, wires, and/or other planar members comprise terminology that may be utilized substantially interchangeably. The weaves affect the light passing through as well as how much light is reflected and how that light reflects, e.g., by scattering or diffusing the light over the entire room.

Preferably transparent or translucent panels 14 and 16 are made of any suitable material such as glass, plastic, lexan, polycarbonates, acrylics, any suitable materials discussed hereinbefore, or any other suitable relatively clear or translucent material such that the wire mesh is visible through the panels. Translucent panels 14 and 16 may be rigid but could also be flexible to a certain extent so that panel 10 may be bendable by a certain amount. For a rigid construction either the translucent panels or the mesh may be rigidly formed. Considerations for panels 14 and 16 may also include insulation properties, clarity, any tinting, tensile strength, and so forth. A single translucent panel may also be utilized wherein the mesh is encapsulated such as by melting into the glass whereby the result is a wall like structure with a relatively large surface area with length and height much larger than the thickness of the panel.

The panels may be designed to provide a selected amount of light to be passed through or reflected such that an architect can make a panel selection based on such considerations. Thus, an architect will be able to design the amount of light coming through the screen such as through skylights, window panels, or the like. Various factors can be controlled in the construction of wire screen to control reflectance, light scattering, and translucence or the amount of light passing through the screen. Such control techniques may comprise selecting one or more of factors such as the wire mesh weave, selecting twists in wires to control reflectance, selecting a percentage of open regions of the wire mesh to affect both reflectance and translucence, selecting one or more cross-sectional shapes for a first plurality of wires and a second plurality of wires which may be woven together, selecting a diameter of the first plurality of wires and the second plurality of wires, selecting a texture of the first plurality of wires and the second plurality of wires and/or selecting a reflectance, gloss, polish, or the like, of the first plurality of wires and the second plurality of wires

In one preferred embodiment, the wire mesh is bonded, epoxied, glued, or the like between panels 14 and 16 and/or other panels as indicated in FIG. 3 utilizing clear adhesive material 18 which may be inserted into the interstices, openings, cracks, and/or gaps between panels 14 and 16 within the wire mesh, such as wire mesh 12B.

Wire meshes 12A and 12B in FIG. 1 and FIG. 2 utilize planar surfaced members such as wires 20A;20B, 22A;22B, 24A;24B, and 26A;26B in a first direction, which may comprise parallel shute filaments. The cross-directional planar surface members or filaments, such as circular cross-section wires 28A;28B, 30A;30B, 32A;32B, 34A;34B, are woven transverse to the first direction, and may be the parallel warp filaments. In a preferred embodiment, the wires or filaments in one direction will be substantially identical, but depending on the equipment utilized for weaving, may not always be so. Generally, warp filaments are those that go along the length of the weave and shute filaments are those that go sideways with respect to the length of the weave. However, the mesh may also be knitted, such as a scrubbing mesh, or welded, or stamped. The welding of a mesh may be utilized to stiffen the mesh or rigid straight wires could be utilized to form a framework that is welded together. Knitted generally refers to stitching techniques which uses two or more knitting needles to make a wire fabric. Stamping may include insertion of a stamping tool to make an opening and then widening the opening.

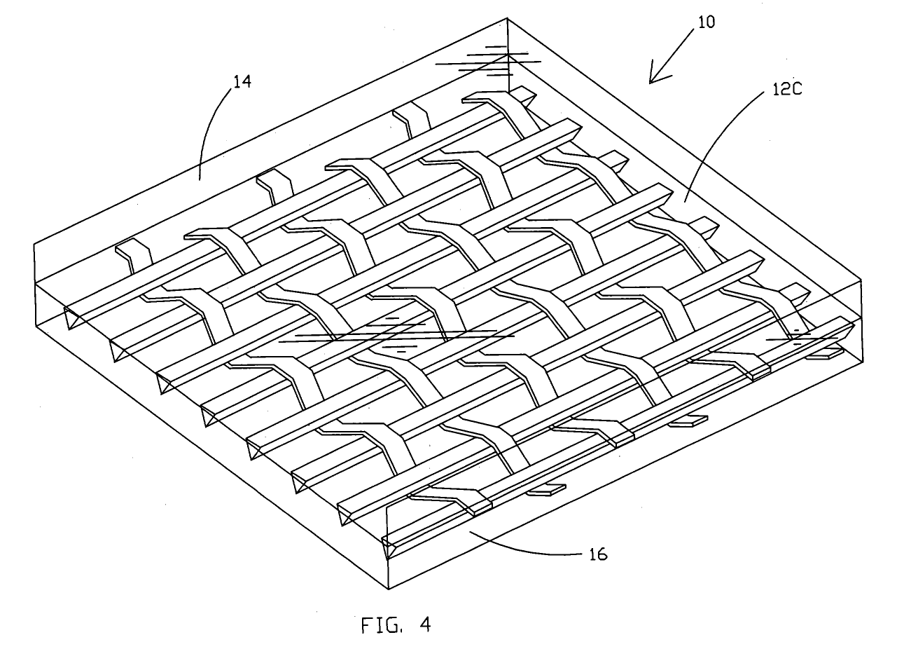

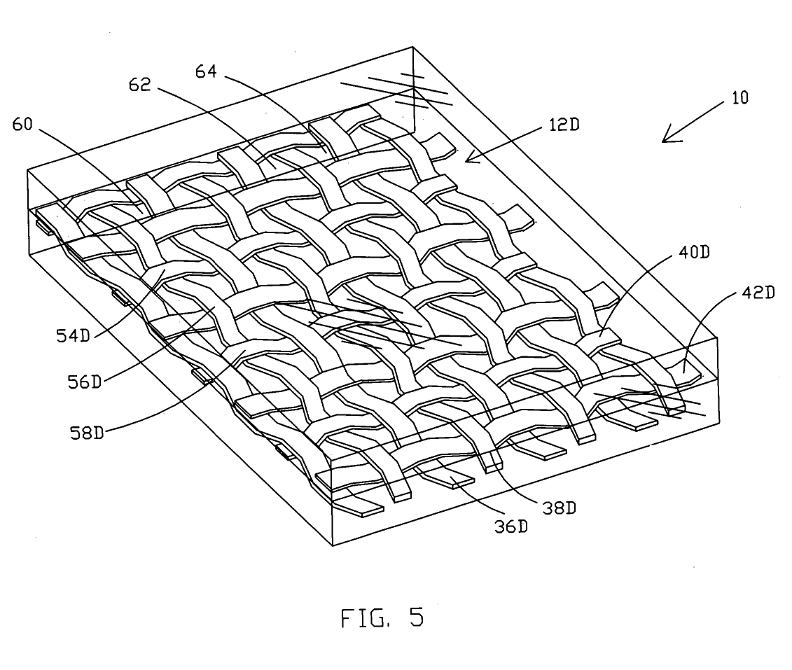

The warp wires and the shute wires may or may not be identical and may have different types of cross-sections as shown in FIG. 4 and FIG. 5. In FIG. 4, wire mesh panel 10 comprises wire mesh 12C, which is woven with different cross-sectional types of planar surfaced wires. While in FIG. 5, the wires are of the same type.

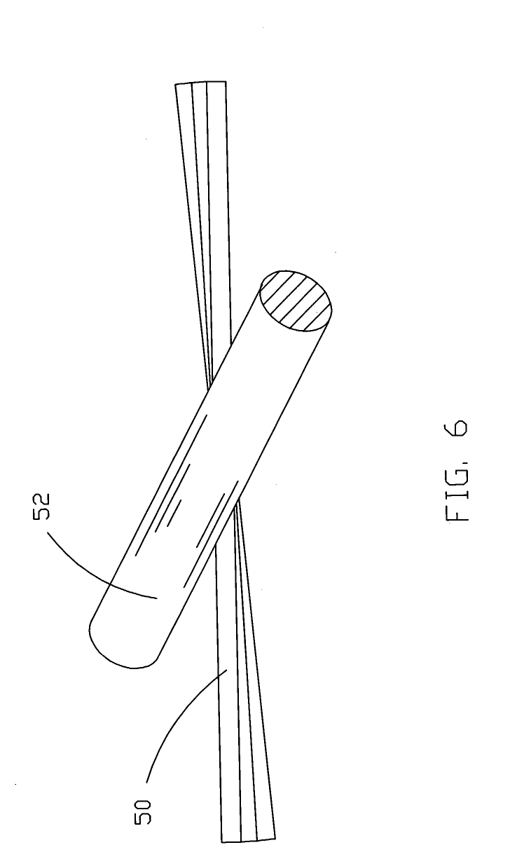

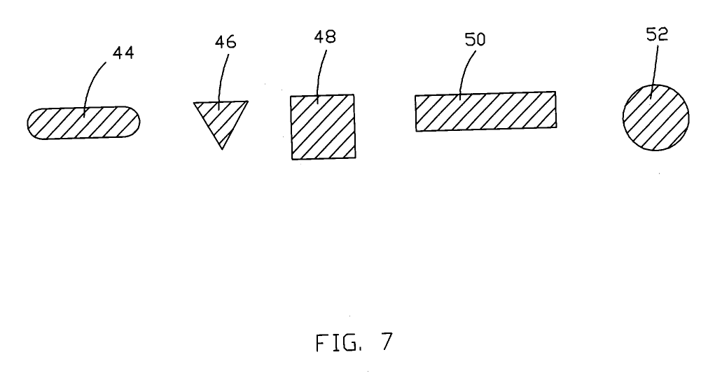

Note that the wires may have much smaller diameters. For instance each warp member 36D, 38D and shute member 40D, 42D might comprise many separate smaller diameter wires. Thus, for instance, 36D may comprise many individual smaller wires which may be unwoven and aligned parallel to each other or which may be woven together to form 36D. Any cross-sectional type of wire may be utilized herein, as indicated in FIG. 7, which shows several different cross-section types of wires including planar wire 44 which may be flat with round corners, triangular wire 46, square wire 48, rectangular wire 50 and round wire 52. Many other types of wires could also be utilized. As shown in FIG. 6, wires of different types such as round wires 52 and rectangular wires 54 may be utilized therein. As indicated in FIG. 6, rectangular cross-section wire may twisted, perhaps randomly or regularly twisted in a mesh, to thereby affect not only the visual effect of the mesh but also the reflectance of the mesh and the diffusion of light reflected and passed by the mesh through panel 10.

Thus, wire mesh panel 10 could be woven with a combination planar and non-planar cross-sectional type members or filaments and with a wide range of different diameter wires. For instance, planar wires, or wires laid together or woven together to form planar members, may be woven with round cross-sectioned wires or wires laid together or woven together to form round members. Planar wires or wires laid to form planar patterns or members may also be woven with different cross-sectioned planar wires or wires laid in planar fashion to form other members, e.g., rectangular cross-sectioned planar wires or members with triangular cross-section planar wires or members.

Referring to intersections 54D, 56D, and 58D in FIG. 5, it will be noted that in a preferred embodiment the wires intersect but do loop around each other. Due to the inherent strength of a mesh with smaller open areas, which may be the result of more wires and/or larger diameter wires, there is no need to wrap or twist the wires completely around each other as per prior art wire mesh safety glass. Thus, the wires typically engage each other, and may slidingly engage each other unless the wire mesh is epoxied or otherwise adhered into position. It will also be noted that in FIG. 5 the open areas of the mesh, such as openings 60, 62, and 64, provide about ten to thirty percent open area as compared to the overall area of the mesh.

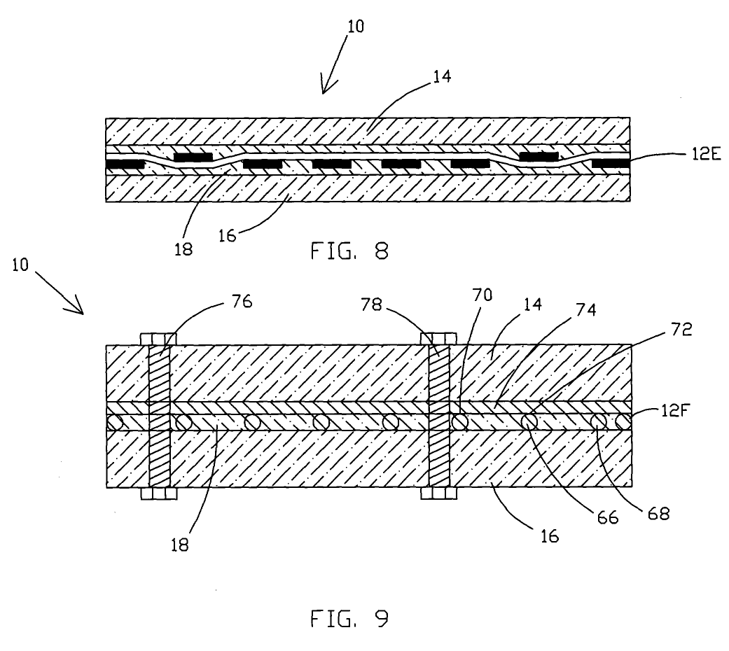

In another embodiment of the invention, planar surface wires such as planar surface wires 36D, 38D, 40D, and 42D in FIG. 5 may be utilized to reduce the overall thickness of mesh 12D, and thus the overall thickness of panel 10. For some types of weaves, the variations produced by the intersections are greatly reduced by reducing the height of intersections to the extent that one side of the weave may effectively have no knuckles or portions extending outwardly from an average height of the mesh. Thus, light reflected may be less diffused when utilizing such weaves. For instance, referring to FIG. 3, it can be seen that on the upper side of mesh 12B adjacent panel 14, the mesh is substantially flat with no knuckles. Other meshes, may utilize, for instance, a five-heddle weave to thereby effectively eliminate the knuckles on one side and also reduce the number of crossing intersections that could produce knuckles. Use of weaves with significant knuckles results in a greater amount of diffusing of the reflected light. Other heddle weaves could also be utilized with more or fewer intersections per row. For instance, intersections where the wires change levels in a row could be spaced by every 2nd-4th planar element in a heddle weave. As another example, the reduced diameter knuckles could be spaced apart by more than five elements or filaments in a heddle weave, and may effectively result in zero knuckles. Wire mesh 12B of FIG. 3 shows a three-heddle weave. Other types of suitable weaves, a few possibilities of which are shown herein, include twill, plain, Dutch weave, twill weave, lock crimped, ride lockcrimped or flat top, weaving combinations, other weaves, and so forth. FIG. 8 shows a five-heddle weave with relatively flat surfaces on either side of mesh 12E.

In yet another embodiment, the wire mesh may utilize wires that are welded at each intersection to provide additional strength, such as shown in the cross-sectional view of FIG. 9. Thus, wires 66 and 68 are welded at intersections 70 and 72 to wire 74 in wire mesh 12F. FIG. 9 also illustrates that, if desired, fasteners such as fasteners 76 and 78 may be utilized for securing panels 14 and 16 together with mesh 12F. Many different types of fasteners could be utilized, as desired. Note that epoxy may or may not be utilized in interstices 18 when fasteners are utilized.

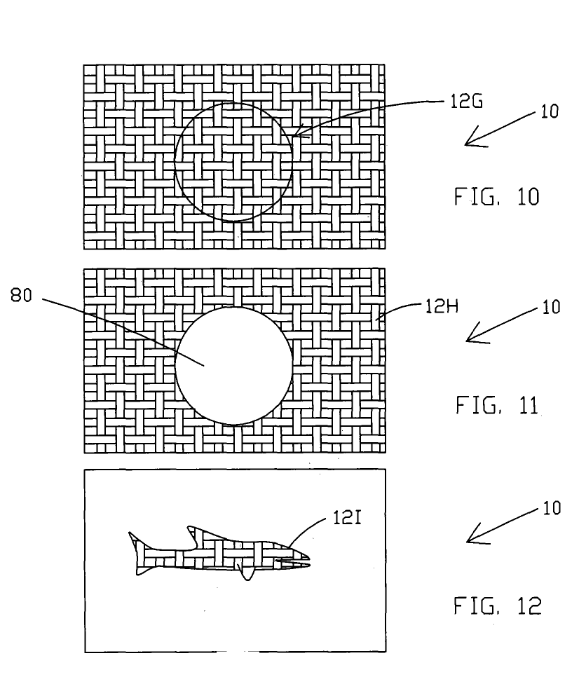

FIG. 10-12 show variations of use of mesh in panels 10. In FIG. 10 circular mesh 12G is utilized. In FIG. 11, mesh 12H provides for port hole 80. In FIG. 12, mesh 121 is in the form of an animal, design, or other arbitrary shape. If desired, in FIG. 10, the center region may be provided as only a screen and with no translucent covering. Thus, panel shown in FIG. 10 may provide a working screen that is mounted in the same way as a panel of glass to thereby avoid the special construction requirements for replacing glass with a screen or for mounting a screen. The center screen could also be utilized as an easily mountable filter for filtering particles such as in a filtering system. Screens mounted in glass may also be utilized with special screens, e.g., interferrometer screens, for use in scientific instruments.

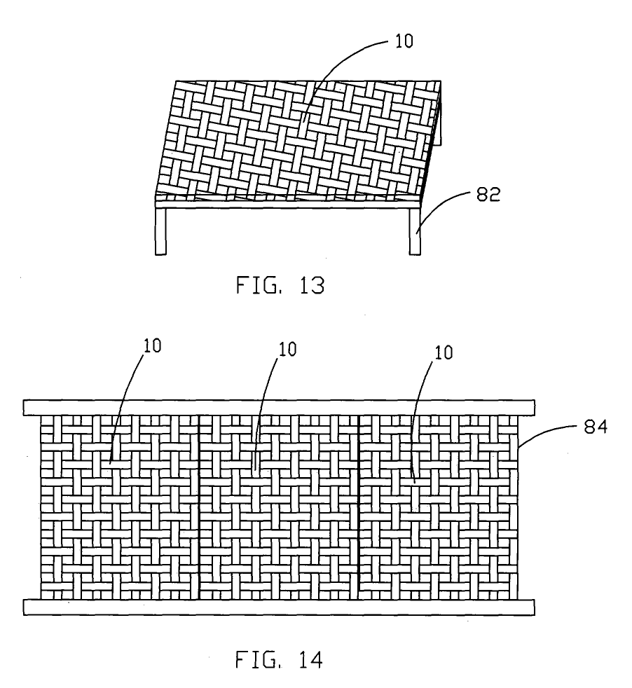

Panel 10 effectively forms construction material that can be utilized in a wide variety of ways. For instance in FIG. 13, panel 10 is mounted as the top in a coffee table or other table 82. Panel 10 may be provided as a counter in a bar or as a counter top for a kitchen. In FIG. 14, multiple panels 10 are mounted together to form a wall 84, such as the wall in an office building, bank, divider walls, shower doors, fireplace glass, balconies, stairs, skylights, or the like.

It will be understood that terms such as wire mesh, screen, and the like are used interchangeably herein. By planar members it is meant herein that at least one surface of the wire, member, or filament contains a plane. A plane is capable of having three points, or a straight line, in a two-dimensional surface. Thus, the planar wires have a flat surface on which a straight line joining any two points would wholly lie. Due to the slight variations caused by the knuckles or intersections where the wires change relative height position in the mesh, the straight line may generally need to be transverse to the length of the wire at any point along the length to more accurately describe, geometrically, a planar wire in accord with the present invention. A round cross-sectional filament or wire does not provide this. Another way to say this is that the member, filament, or wire has a flat side that is uniform along its length. Thus, the shape of the cross-section will preferably be continuous along the length of the member, filament, or wire. Thus, calendaring an already woven screen will not produce planar members as discussed herein, because calendared filaments or wires do not have substantially the same cross-section along their length. Instead, calendaring will produce variations in the cross-sections of the wires or filaments at the knuckles. However, calandared screens may also be utilized in accord with the present invention.

Moreover, the woven planar filament meshes of the present invention may be molded into other shapes, which may not be flat, or which may be pleated or rounded, and may be utilized in any desirable shape within any type of filtration equipment which may not utilize vibration but may also utilize pressure or other means of filtration. It will be understood from review of the disclosure of the present invention that many different types of weaves and combinations utilizing woven planar members in accord with the present invention may be utilized.

The woven planar wires may comprise fibers of various types, stainless steel, carbon steel, other metallic materials, combinations thereof, plastics, or any other suitable material. A screen in accord with one possible embodiment of the present invention is preferably woven. One advantage of woven screens is a built-in resistance against vibration and the strength thereof as may be desirable for certain construction projects.

Thus, the foregoing disclosure and description of the invention is therefore illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents, as well as in the details of the illustrated construction or combinations of features of the various elements, may be made without departing from the spirit of the invention. As well, the drawings are intended to describe the concepts of the invention so that the presently preferred embodiments of the invention will be plainly disclosed to one of skill in the art but are not intended to be manufacturing-level drawings or renditions of final products and may include simplified conceptual views as desired for easier and quicker understanding or explanation of the invention. It will be seen that various changes and alternatives may be used that are contained within the spirit of the invention. Moreover, it will be understood that various directions such as “upper,” “lower,” “bottom,” “top,” “left,” “right,” “inwardly,” “outwardly,” and so forth are made only with respect to easier explanation in conjunction with the drawings and that the components may be oriented differently, for instance, during transportation and manufacturing as well as operation. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1. A method for making construction material comprising a decorative substantially flat panel, said method comprising:
determining a desired amount of light to be passed by said flat panel ranging from zero percent to eighty-five percent;
controlling construction of a wire mesh comprising a first plurality of wires and a second plurality of wires to provide said desired amount of light to be passed by said flat panel; and
mounting said wire mesh to said one or more plates of substantially transparent material.

2. The method of claim 1 wherein said step of controlling comprises controlling at least two of a group consisting of selecting a wire mesh weave, selecting twists in wires, selecting a percentage of open regions of said wire mesh, selecting one or more cross-sectional shapes for said first plurality of wires and said second plurality of wires, selecting a diameter of said first plurality of wires, selecting a metal or alloy, and said second plurality of wires.

3. A method for making construction material comprising a decorative substantially flat panel, said method comprising:
determining a desired amount of light to be reflected by said flat panel ranging from fifteen percent to one hundred percent;
controlling construction of a wire mesh comprising a first plurality of wires and a second plurality of wires to provide said desired amount of light to be reflected by said flat panel; and
mounting said wire mesh to said one or more plates of substantially transparent material.

4. The method of claim 3 wherein said step of controlling comprises controlling at least two of a group consisting of selecting a wire mesh weave, selecting twists in wires, selecting a percentage of open regions of said wire mesh, selecting one or more cross-sectional shapes for said first plurality of wires and said second plurality of wires, selecting a diameter of said first plurality of wires and said second plurality of wires, selecting a texture of said first plurality of wires and said second plurality of wires, selecting a metal or alloy, and selecting a reflectance of said first plurality of wires and said second plurality of wires.

5. A decorative substantially flat construction assembly easily cleaned so as to be suitable for use in hygenic environments, comprising:
one or more layers of substantially transparent material with a smooth surface; and
a wire mesh mounted within said one or more layers of substantially transparent material, said wire mesh comprising a first plurality of wires and a second plurality of wires, said first plurality of wires being interwoven or knitted with said second plurality of wires, said wire mesh having a total surface area, said wire mesh defining openings therein that permit light through said wire mesh whereby a percentage of said openings with respect to said total surface area of said wire mesh is in a range from zero to eighty-five percent.

6. The decorative construction assembly of claim 5, further comprising:
said first plurality of wires interconnecting with said second plurality of wires at a plurality of intersections in at least one weave pattern, each of said plurality of intersections comprising individual wires extending therefrom whereby said individual wires engage each other but are not twisted around each other so as to loop around each other.

7. The decorative construction assembly of claim 5, further comprising a transparent adhesive for securing said wire mesh within at least one first layer of substantially transparent material and at least one second layer of substantially transparent material.

8. The decorative construction assembly of claim 5, wherein said wire mesh has a lustrous surface.

9. The decorative construction assembly of claim 5, wherein said second plurality of wires have a cross-section with at least one planar side.

10. The decorative construction assembly of claim 5, wherein said first plurality of wires or said second plurality of wires have a non-round cross-section.

11. The decorative construction assembly of claim 5, wherein said construction assembly forms a portion of a building wall.

12. The decorative construction material of claim 5, wherein said construction assembly forms a portion of an article of furniture.

13. The decorative construction assembly of claim 5, wherein said wire mesh is woven with a twilled weave or variation thereof.

14. The decorative construction assembly of claim 5, wherein said wire mesh is woven in a Dutch weave or variation thereof.

15. The decorative construction assembly of claim 5, wherein said wire mesh is woven in a heddle weave or variation thereof.

16. The decorative construction assembly of claim 5, wherein said percentage of said openings with respect to said total surface area of said wire mesh is in a range of from zero to seventy percent.

17. The decorative construction assembly of claim 5, wherein said percentage of said openings with respect to said total surface area of said wire mesh is in a range of from zero to fifty percent.

18. The decorative construction assembly of claim 5, wherein said percentage of said openings with respect to said total surface area of said wire mesh is in a range of from zero to forty percent.

19. The decorative construction assembly of claim 5, wherein said percentage of said openings with respect to said total surface area of said wire mesh is in a range of from zero to twenty-five percent.

20. The decorative construction assembly of claim 5, wherein said percentage of said openings with respect to said total surface area of said wire mesh is in a range of from zero to ten percent.

21. The decorative construction assembly of claim 5, wherein said one or more substantially transparent layers and said wire mesh are substantially flexible such that said decorative substantially flat construction assembly is bendable.

22. The decorative construction assembly of claim 5, wherein said wire mesh is welded together.

23. The decorative construction assembly of claim 5, wherein said wire mesh is not welded together.

24. A method for making a decorative substantially flat construction material, said method comprising:
combining a first plurality of planar wires with a second plurality of wires to form a wire mesh, providing that said wire mesh has between zero and eighty five percent open areas through said mesh;
mounting said wire mesh to said one or more substantially transparent panels; and
securing said wire mesh to said plurality of substantially transparent panels.

25. The method of claim 24 wherein said step of affixing further comprises adhering said wire mesh within said one or more substantially transparent panels.

26. The method of claim 25 wherein said step of affixing further comprises fastening said wire mesh within said one or more substantially transparent panels with one or more fasteners.

27. The method of claim 24, further comprising:
providing that individual wires in said wire mesh intersect without looping completely around each other.

28. A method for construction, comprising:
providing a wall portion affixed to a building structure and comprising a wire mesh embedded within one or more translucent panels, said wire mesh comprising a plurality of filaments with diameters and arrangement such that open area through said wire mesh comprises less than eighty-five percent of an overall area of said wire mesh; and
mounting said wall portion.

29. The method of claim 28, further comprising mounting said wall portion in furniture.

30. The method of claim 28, further comprising mounting said wall portion as a wall for a building.

31. The method of claim 28, further comprising cutting said wire mesh into a desired pattern.

32. The method of claim 28, further comprising providing said wire meshed with a lustrous surface.

33. The method of claim 28, further comprising providing said wire filaments in a selected weave or knitted pattern.

34. The method of claim 28, further comprising providing that said wire filaments are not welded together.

35. The method of claim 28, further comprising providing that said open area through said wire mesh comprises less than fifty percent of an overall area of said wire mesh.

36. The method of claim 28, further comprising providing that said open area through said wire mesh comprises less than forty percent of an overall area of said wire mesh.

37. A decorative substantially flat construction assembly, comprising:
one or more panes of substantially transparent material; and
a substantially uniform metallic structure mounted therein therein with regularly spaced openings that permit light through said substantially uniform metallic structure whereby a percentage of said openings with respect to said total surface area of said substantially uniform metallic structure is in a range from zero to forty percent.

38. The decorative substantially flat construction assembly of claim 37, wherein said one or more panes and said substantially uniform metallic structure is substantially flexible such that said decorative substantially flat construction assembly is bendable.

39. The decorative substantially flat construction assembly of claim 37, wherein said substantially uniform metallic structure comprises a stamped metallic plate mounted within said one or more panes of substantially transparent material.

40. The decorative substantially flat construction assembly of claim 37, wherein said substantially uniform metallic structure comprises a woven mesh within said one or more panes of substantially transparent material.

41. The decorative substantially flat construction assembly of claim 37, wherein said substantially uniform metallic structure comprises a knitted mesh within said one or more panes of substantially transparent material.
